(19) United States
(12) Patent Application Publication
(10) Pub. No.: US 2026/0239279 A1
(43) Pub. Date: Aug. 13, 2026

(54) SIDELINK POSITIONING SECURITY

(71) Applicant: Nokia Technologies Oy, Espoo (FI)

(72) Inventors: Stepan KUCERA, Munich (DE); Diomidis MICHALOPOULOS, Munich (DE); Prajwal KESHAVAMURTHY, Munich (DE); Rakshesh PRAVINCHANDRA BRATT, Bangalore (IN); Jing PING, Chengdu (CN)

(21) Appl. No.: 19/156,534

(22) PCT Filed: Feb. 17, 2023
(86) PCT No.: PCT/CN2023/076706

§ 371 Date: Aug. 14, 2025

(51) Int. Cl. H04W 64/00; H04W 12/0433; H04W 60/00; H04W 92/18

(52) U.S. Cl. CPC H04W 64/00; H04W 12/0433; H04W 60/00; H04W 92/18

(57) ABSTRACT

Embodiments of the present disclosure relate to sidelink positioning security. A first terminal device sends a first request message to a first network device or a second terminal device. Then the first network device requests an ID related to group from a second network device. Next, the first network device or the second terminal device sends, to the first terminal device, a reply message comprising a group specific key for sidelink groupcast/broadcast communications in a group of terminal devices for sidelink positioning. Thus, an improved solution for the security of SL groupcast/broadcast communication is provided.

### FIELD

Various example embodiments relate to the field of telecommunication and in particular, to a devices, methods, apparatuses and a computer readable storage medium for sidelink positioning security.

### BACKGROUND

In the communications area, there is a constant evolution ongoing in order to provide efficient and reliable solutions for utilizing wireless communication networks. Each new generation has it owns technical challenges for handling the different situations and processes that are needed to connect and serve devices connected to the wireless network. To meet the demand for wireless data traffic having increased since deployment of fourth generation (4G) communication systems, efforts have been made to develop an improved fifth generation (5G) or pre-5G communication system. The new communication systems can support various types of service applications for terminal devices.

The positioning of user equipment (UE), such as a cellular telephone, may be useful or essential to a number of applications including emergency calls, navigation, direction finding, asset tracking and Internet service. The location of the UE may be estimated based on information gathered from various systems. In the existing positioning technologies, sidelink (SL) positioning provides a means to determine the geographic position and/or velocity of the user equipment (UE) based on measuring radio signals. It is still desirable for improved solutions of the sidelink positioning.

### SUMMARY

In general, example embodiments of the present disclosure provide a solution for sidelink positioning.

In a first aspect, there is provided a first network device. The first network device comprises at least one processor; and at least one memory storing instructions that, when executed by the at least one processor, cause the first network device at least to: receive, from a terminal device, a first request message comprising a first identifier (ID) related to user equipment (UE) of the terminal device; and send, to the terminal device, a first reply message comprising a group specific key for sidelink groupcast/broadcast communications in a group of terminal devices for sidelink positioning.

In a second aspect, there is provided a second network device. The second network device comprises at least one processor; and at least one memory storing instructions that, when executed by the at least one processor, cause the second network device at least to: receive a request message associated with a first identifier (ID) from a first network device to request a second ID related to group associated with the first ID, wherein the first ID is related to user equipment (UE) of a terminal device, and the second ID is indicative of a group of terminal devices for sidelink positioning; and send, to the first network device, a reply message comprising the second ID associated with the first ID.

In a third aspect, there is provided a third network device. The third network device comprises at least one processor; and at least one memory storing instructions that, when executed by the at least one processor, cause the third network device at least to: generate a group specific key for sidelink groupcast/broadcast communications in a group of terminal devices for sidelink positioning; and send the group specific key to a first network device or a second network device.

In a fourth aspect, there is provided a first terminal device. The first terminal device comprises at least one processor; and at least one memory storing instructions that, when executed by the at least one processor, cause the first terminal device at least to: send, to a network device or a second terminal device, a request message comprising an identifier (ID) related to user equipment (UE) of the first terminal device; and receive, from the network device or the second terminal device, a reply message comprising a group specific key for sidelink groupcast/broadcast communications in a group of terminal devices for sidelink positioning.

In a fifth aspect, there is provided a second terminal device. The second terminal device comprises at least one processor; and at least one memory storing instructions that, when executed by the at least one processor, cause the second terminal device at least to: generate a group specific key for sidelink groupcast/broadcast communications in a group of terminal devices for sidelink positioning; receive, from a first terminal device in the group of terminal devices, a request message comprising an identifier (ID) related to user equipment (UE) of the first terminal device; and send, to the first terminal device, a reply message comprising the group specific key.

In a sixth aspect, there is provided a method. The method comprises: receiving, at a first network device from a terminal device, a request message comprising an identifier (ID) related to user equipment (UE) of the terminal device; and sending, to the terminal device, a reply message comprising a group specific key for sidelink groupcast/broadcast communications in a group of terminal devices for sidelink positioning In a seventh aspect, there is provided a method. The method comprises: receiving, at a second network device, a request message associated with a first identifier (ID) from a first network device to request a second ID related to group associated with the first ID, wherein the first ID is related to user equipment (UE) of a terminal device, and the second ID is indicative of a group of terminal devices for sidelink positioning; and sending, to the first network device, a reply message comprising the second ID associated with the first ID.

In an eighth aspect, there is provided a method. The method comprises: generating, at a third network device, a group specific key for sidelink groupcast/broadcast communications in a group of terminal devices for sidelink positioning; and sending the group specific key to a first network device or a second network device.

In a ninth aspect, there is provided a method. The method comprises: sending, at a first terminal device to a network device or a second terminal device, a request message comprising an identifier (ID) related to user equipment (UE) of the first terminal device; and receiving, from the network device or the second terminal device, a reply message comprising a group specific key for sidelink groupcast/broadcast communications in a group of terminal devices for sidelink positioning.

In a tenth aspect, there is provided a method. The method comprises: generating, at a second terminal device, a group specific key for sidelink groupcast/broadcast communications in a group of terminal devices for sidelink positioning; receiving, from a first terminal device in the group of terminal devices, a request message comprising an identifier (ID) related to user equipment (UE) of the first terminal device; and sending, to the first terminal device, a reply message comprising the group specific key.

In an eleventh aspect, there is provided an apparatus comprising: means for receiving, at a first network device from a terminal device, a request message comprising an identifier (ID) related to user equipment (UE) of the terminal device; and means for sending, to the terminal device, a reply message comprising a group specific key for sidelink groupcast/broadcast communications in a group of terminal devices for sidelink positioning.

In a twelfth aspect, there is provided an apparatus comprising: means for receiving, at a second network device, a request message associated with a first identifier (ID) from a first network device to request a second ID related to group associated with the first ID, wherein the first ID is related to user equipment (UE) of a terminal device, and the second ID is indicative of a group of terminal devices for sidelink positioning; and means for sending, to the first network device, a reply message comprising the second ID associated with the first ID.

In a thirteenth aspect, there is provided an apparatus comprising: means for generating, at a third network device, a group specific key for sidelink groupcast/broadcast communications in a group of terminal devices for sidelink positioning; and means for sending the group specific key to a first network device or a second network device.

In a fourteenth aspect, there is provided an apparatus comprising: means for sending, at a first terminal device to a network device or a second terminal device, a request message comprising an identifier (ID) related to user equipment (UE) of the first terminal device; and means for receiving, from the network device or the second terminal device, a reply message comprising a group specific key for sidelink groupcast/broadcast communications in a group of terminal devices for sidelink positioning.

In a fifteenth aspect, there is provided an apparatus comprising: means for generating, at a second terminal device, a group specific key for sidelink groupcast/broadcast communications in a group of terminal devices for sidelink positioning; means for receiving, from a first terminal device in the group of terminal devices, a request message comprising an identifier (ID) related to user equipment (UE) of the first terminal device; and means for sending, to the first terminal device, a reply message comprising the group specific key.

In a sixteenth aspect, there is provided a non-transitory computer readable medium comprising program instructions for causing an apparatus to perform at least the method according to any one of the above sixth to tenth aspects.

In an eleventh aspect, there is provided a computer program comprising instructions, which, when executed by an apparatus, cause the apparatus at least to perform at least the method according to any one of the above sixth to tenth aspects.

In a seventeenth aspect, there is provided a first network device. The first network device comprises receiving circuitry configured to receive, from a terminal device, a first request message comprising a first identifier (ID) related to user equipment (UE) of the terminal device; and sending circuitry configured to send, to the terminal device, a first reply message comprising a group specific key for sidelink groupcast/broadcast communications in a group of terminal devices for sidelink positioning.

In an eighteenth aspect, there is provided a second network device. The second network device comprises receiving circuitry configured to receive a request message associated with a first identifier (ID) from a first network device to request a second ID related to group associated with the first ID, wherein the first ID is related to user equipment (UE) of a terminal device, and the second ID is indicative of a group of terminal devices for sidelink positioning; and sending circuitry configured to send, to the first network device, a reply message comprising the second ID associated with the first ID.

In a nineteenth aspect, there is provided a third network device. The third network device comprises generating circuitry configured to generate a group specific key for sidelink groupcast/broadcast communications in a group of terminal devices for sidelink positioning; and sending circuitry configured to send the group specific key to a first network device or a second network device.

In a twentieth aspect, there is provided a first terminal device. The first terminal device comprises sending circuitry configured to send, to a network device or a second terminal device, a request message comprising an identifier (ID) related to user equipment (UE) of the first terminal device; and receiving circuitry configured to receive, from the network device or the second terminal device, a reply message comprising a group specific key for sidelink groupcast/broadcast communications in a group of terminal devices for sidelink positioning.

In a twenty-first aspect, there is provided a second terminal device. The second terminal device comprises generating circuitry configured to generate a group specific key for sidelink groupcast/broadcast communications in a group of terminal devices for sidelink positioning; receiving circuitry configured to receive, from a first terminal device in the group of terminal devices, a request message comprising an identifier (ID) related to user equipment (UE) of the first terminal device; and sending circuitry configured to send, to the first terminal device, a reply message comprising the group specific key.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example communication network in which embodiments of the present disclosure may be implemented;

FIG. 2 illustrates an example diagram illustrating a process for securing sidelink groupcast/broadcast communications according to some embodiments of the present disclosure;

FIG. 3 illustrates an example diagram illustrating a process for securing sidelink groupcast/broadcast communications according to some embodiments of the present disclosure;

FIG. 4 illustrates a further example diagram illustrating a process for securing sidelink groupcast/broadcast communications according to some embodiments of the present disclosure;

FIG. 5 illustrates an example diagram illustrating a process for securing sidelink groupcast/broadcast communications according to some embodiments of the present disclosure;

FIG. 6 illustrates a flowchart of a method implemented at a network device according to some embodiments of the present disclosure;

FIG. 7 illustrates a flowchart of another method implemented at a network device according to some embodiments of the present disclosure;

FIG. 8 illustrates a flowchart of a further method implemented at a network device according to some embodiments of the present disclosure;

FIG. 9 illustrates a flowchart of a method implemented at a terminal device according to some other embodiments of the present disclosure;

FIG. 10 illustrates a flowchart of another method implemented at a terminal device according to some other embodiments of the present disclosure;

FIG. 11 illustrates a simplified block diagram of an apparatus that is suitable for implementing embodiments of the present disclosure; and

FIG. 12 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” or “network element” refers to a node in a communication network via which a terminal device accesses the network and receives services therefrom. The communication network may be a core network (CN). The network device or element in CN (also referred to as core network element herein) may refer to a policy control function (PCF), an access management function (AMF), a session management function (SMF), a user plane function (UPF), unified data management (UDM), unified data repository (UDR), an authentication server function (AUSF), a ProSe key management function (PKMF), a direct discovery name management function (DDNMF), a network exposure function (NEF), etc..

The communication network may be a radio access network (RAN). The network device or element in RAN may refer to a base station (BS) or an access point (AP), for example, a node B (NodeB or NB), an evolved NodeB (eNodeB or eNB), a NR next generation NodeB (also referred to as a gNB), a Remote Radio Unit (RRU), a radio header (RH), a remote radio head (RRH), a relay, a low power node such as a femto, a pico, and so forth, depending on the applied terminology and technology. A radio access network (RAN) split architecture comprises a gNB-CU (centralized unit, hosting radio resource control (RRC), service data adaptation protocol (SDAP) and packet data convergence protocol (PDCP) layers) controlling a plurality of gNB-DUs (distributed unit, hosting radio link control (RLC), medium access control (MAC) and physical (PHY) layers).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

Some embodiments of the present disclosure concern the case of SL positioning, where a target UE positions itself by measuring SL positioning reference signals (PRS) emitted by other UEs, referred to as anchor UEs. The coordination of the SL PRS resources is done either at the network side, at the location management function (LMF) entity or by another UE referred to as the server UE. The LMF or the server UE is also the entity that administers the security aspects of positioning, thereby managing the cipher keys (CK).

As for the SL positioning mentioned above, certain positioning signaling, such as SL positioning capability and SL positioning assistance data, need to be transmitted between terminal device(s) or/and network device(s). Groupcast and broadcast communications for sidelink positioning are necessary for efficient data dissemination. For example, broadcast of configuration/assistance data can eliminate the need for multiple unicast sessions, each preceded by complex signalling and thus involving non-negligible delay and overhead.

To enable group/broadcast, two candidate layers (such as PDCP and PC5-U) are provided for group/broadcast transport. However, neither of the two candidate layers supports secure communications to protect sensitive information, such as node location (e.g. anchor location) and/or its precursors (e.g. time-of-arrival measurements). Thus, security issues on specific information of SL positioning capability and assistance data during groupcast/broadcast communication need to be addressed.

Further, there are following limitations for the security of groupcast and broadcast communications for sidelink positioning. For example, a change in the registration procedure and proposes inclusion of new fields specifically for SL Positioning Protocol (SLPP) groupcast/broadcast is required. Only in-coverage scenario is applicable. New type of keys for SL positioning via PC5 communication overlaps with existing PC5 protection solution. Locations of UEs in communication is not validated before providing keys. The roles of “target UE” and “reference UE” seem to be swapped from groupcast/broadcast perspective. Malicious server UEs may be an additional threat. The limitation for UEs out of 5G coverage is a challenge. Session-less and light-weight requirements that UEs may want to just listen to some broadcast cannot be satisfied. Automated moving vehicles may want to just listen to some broadcast/groupcast which maybe providing useful information about the route or location. Sending UEs do not have any control on which UEs can receive the messages. Locations of UEs in communication is not validated before providing keys.

Further, if the group information is not securely converted by the application layer, the intruder can link them back to UE groupcast memberships, revealing which UEs have been associated with a specific group and hence causes privacy attacks. When the protection for SL groupcast/broadcast communications fails, there are following threats. For example, passive attackers can eavesdrop on data packets exchanged between UEs. Active attackers can intercept, modify or replay data packets exchanged between UEs. An UE as a group member may be impersonated by an attacker. It can be seen that the security of SL groupcast/broadcast communication needs to be improved. Currently, there is no known solution to the above-mentioned problem of secure group/broadcast for sidelink positioning in a manner conforming with 3GPP specifications.

In view of this, embodiments of the present disclosure provide a solution for securing groupcast/broadcast in sidelink positioning. In the solution, a terminal device sends a request message to a network device or another terminal device. The request message comprises an identifier (ID) related to UE of the terminal device. In response to the reception of the request message, the network device or another terminal device can send a reply message to the terminal device. The reply message comprises a group specific key for sidelink groupcast/broadcast communications in a group of terminal devices for sidelink positioning. The group specific key can be used for sidelink groupcast/broadcast communications in a group of terminal devices for sidelink positioning.

In this way, an improved solution for the security of SL groupcast/broadcast communication is provided. With the aid of cipher key management function of LMF and keys distribution function of AMF, some embodiments of the present disclosure involves how keys are generated, how the keys are assigned to various UE groups, and how the keys are employed in different types of positioning, etc.

Principles and implementations of the present disclosure will be described in detail below with reference to the figures.

### EXAMPLE OF COMMUNICATION ENVIRONMENT

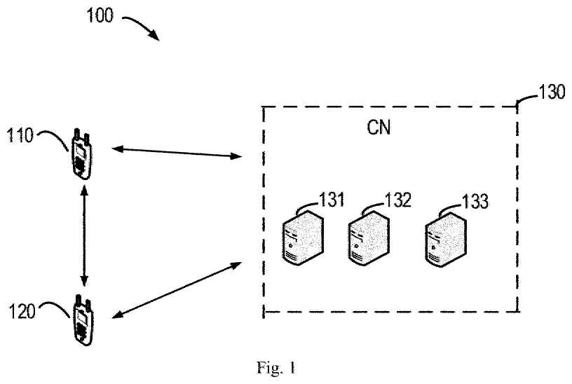

FIG. 1 illustrates a schematic diagram of an example communication environment 100 in which embodiments of the present disclosure can be implemented. As shown in FIG. 1, the communication environment 100 may involve a plurality of devices (such as devices 110 and 120), and a core network (CN) 130.

In this example, the devices 110 and 120 are illustrated as mobile phones. It should be noted that any of the devices 110 and 120 may be any other suitable types of terminal devices or network devices. Further, it is to be understood that the number of the devices is only for the purpose of illustration without suggesting any limitations. The communication environment 100 may include any suitable number or type of the devices adapted for implementing embodiments of the present disclosure.

As shown in FIG. 1, the CN 130 may comprise a plurality of CN elements, for example, an AMF 131, an LMF 132, and a PKMF 133. It is to be understood that the CN elements in CN 130 are only for the purpose of illustration without suggesting any limitations. The communication environment 100 may include more or less CN elements adapted for implementing embodiments of the present disclosure.

In some embodiments, the devices 101 and 102 may communicate with each other, with the core network 130 via a radio access network (RAN). The RAN may comprise any suitable network devices (not shown) and may adopt any suitable RAN technologies. It is to be understood that the communication environment 100 may include any suitable number or type of the RANs and CNs adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

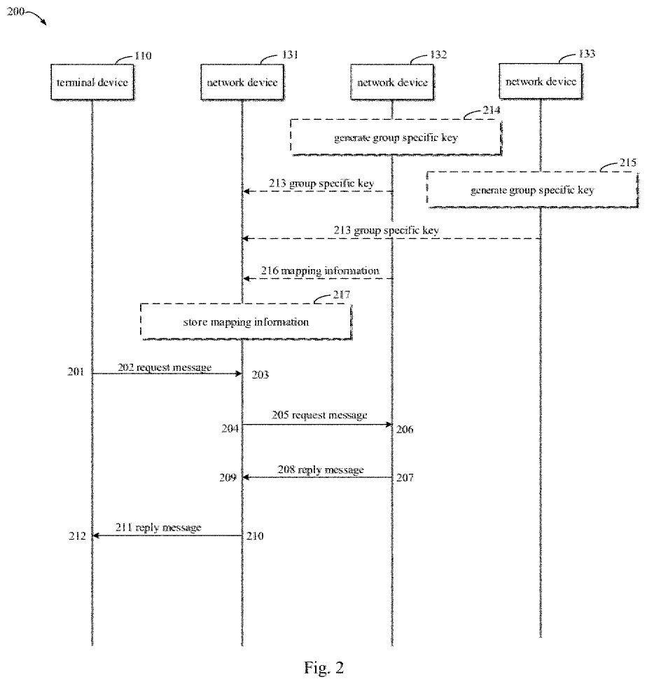

Reference is now made to FIG. 2, which shows a process 200 for securing sidelink groupcast/broadcast communications according to various embodiments of the present disclosure. For the purpose of discussion, the process 200 will be described with reference to FIG. 1. The process 200 may involve the terminal devices 110 and 120, and the network devices 131, 132, and 133 as illustrated in FIG. 1. It is to be appreciated that any graphic elements, numerical values, and descriptive text in these figures are only for the purpose of illustration without suggesting any limitations.

In the process 200, the terminal device 110 sends (201) a request message 202 to the network device 131. The request message comprises an identifier (ID) associated with UE of the terminal device 110. In an example, the ID associated with UE of the terminal device 110 may be “session ID” or “positioning process ID” that the UE could use to request a particular cipher key. It is to be understood that one UE could have many “session IDs” if it is involved in multiple sessions.

At the network side, after receiving (203) the request message 202, the network device 131 sends (204) another request message 205 to the network device 132. The request message 205 is associated with the ID related to UE to request an ID related to group. For example, the ID related to UE may be processed and forwarded by the request message 205. The ID related to group is associated with the ID related to UE, and is indicative of a group of terminal devices for sidelink positioning.

Accordingly, the network device 132 receives (206) the request message 205, and sends (207) a reply message 208 to the network device 131. The reply message 208 comprises the ID related to group. Then, the network device 131 can obtain the ID related to group from the reply message 208 after receiving (209) the reply message 208, and send (210) another reply message 211 to the terminal device 110. The reply message 211 can contain a group specific key 213 used for sidelink groupcast/broadcast communications in a group of terminal devices for sidelink positioning, and be received (212) by the terminal device 110.

In an example, the group specific key 213 may be generated (214) by the network device 132, and transmitted from the network device 132 to the network device 131. The network device 131 may receive the group specific key 213 from the network device 132 before receiving the request message 202 from the terminal device 110. In another example, the group specific key 213 may be generated (215) by the network device 133 or other function block in the CN 130, and transmitted from the network device 133 to the network device 131. The network device 131 may receive the group specific key 213 from the network device 133 before receiving the request message 202 from the terminal device 110. In yet another example, the group specific key 213 may be generated (215) by the network device 133 or other function block in the CN 130, and transmitted from the network device 133 to the network device 132. The network device 131 may receive the group specific key 213 from the network device 132 before receiving the request message 202 from the terminal device 110.

In some embodiments, prior to receiving the request message 202 from the terminal device 110, the network device 131 may receive mapping information 216 between the ID related to group and the group specific key from the network device 132, and store (217) the mapping information 216. In an example, the mapping information 216 may be generated in the following way. For example, prior to receiving the request message 205 from the network device 131, the network device 132 may assign a group specific key with an ID related to group. Additionally or alternatively, the network device 131 may assign the ID associated with UE to the ID related to group based on the received reply message 208 from the network device 132. Thus, mapping information between an ID associated with UE and an ID related to group may be stored by the network device 131. In this way, for example, the network device 131 may determine a group specific key based on the ID related to group in the received reply message 208 and mapping information.

In some embodiments, the group specific key is used for session-based sidelink positioning. The session-based sidelink positioning refers to positioning involving bidirectional communication between the target UE and at least one anchor UE, where such communication involves exchange of acknowledged control signals.

Additionally or alternatively, the reply message 208 may comprise a non-specific key for sidelink communications of the terminal device 110 for sidelink positioning. In an example, the non-specific key may be generated by the network device 133 or other function block in the CN 130, and transmitted from the network device 133 to the network device 132. The network device 132 may transmit the non-specific key to the network device 131. The terminal device 110 may receive the non-specific key from the network device 131 via same or similar request and replay messages as described with the specific key above. In another example, the non-specific key may be generated by the network device 132, and transmitted from the network device 132 to the network device 131. The terminal device 110 may receive the non-specific key from the network device 131 via same or similar request and replay messages as described with the specific key above.

In an example, the non-specific key is used for session-less sidelink positioning. The session-less sidelink positioning refers to the positioning process that does not involve any exchange of acknowledged control signals between the target UE and the anchor UE(s).

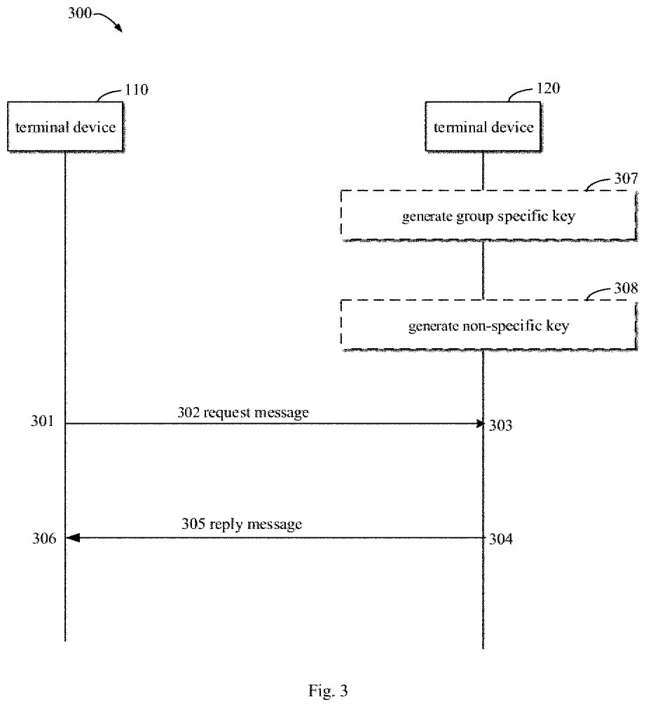

Reference is now made to FIG. 3, which shows a process 300 for securing sidelink groupcast/broadcast communications according to various embodiments of the present disclosure. For the purpose of discussion, the process 300 will be described with reference to FIG. 1. The process 300 may involve the terminal devices 110 and 120 as illustrated in FIG. 1. It is to be appreciated that any graphic elements, numerical values, and descriptive text in these figures are only for the purpose of illustration without suggesting any limitations.

As shown in FIG. 3, the terminal device 110 sends (301) a request message 302 to the terminal device 120. The request message 302 comprises an ID related to UE of the terminal device 110. Accordingly, the terminal device 120 receives (303) the request message from the terminal device 110 in a group of terminal devices. And the terminal device 120 sends (304) a reply message 305 to the terminal device 110. A group specific key is contained in the reply message 305. Accordingly, the terminal device 110 receive (306) the reply message 305 and obtain the group specific key used for sidelink groupcast/broadcast communications in a group of terminal devices for sidelink positioning. In an example, the terminal device 120 may generate (307) the group specific key. In another example, the terminal device 120 may obtain the group specific key generated by other function block.

Additionally or alternatively, the reply message may comprise a non-specific key for sidelink communications of the first terminal device for sidelink positioning. In an example, the terminal device 120 may generate (308) the non-specific key. In another example, the terminal device 120 may obtain the non-specific specific key generated by other function block.

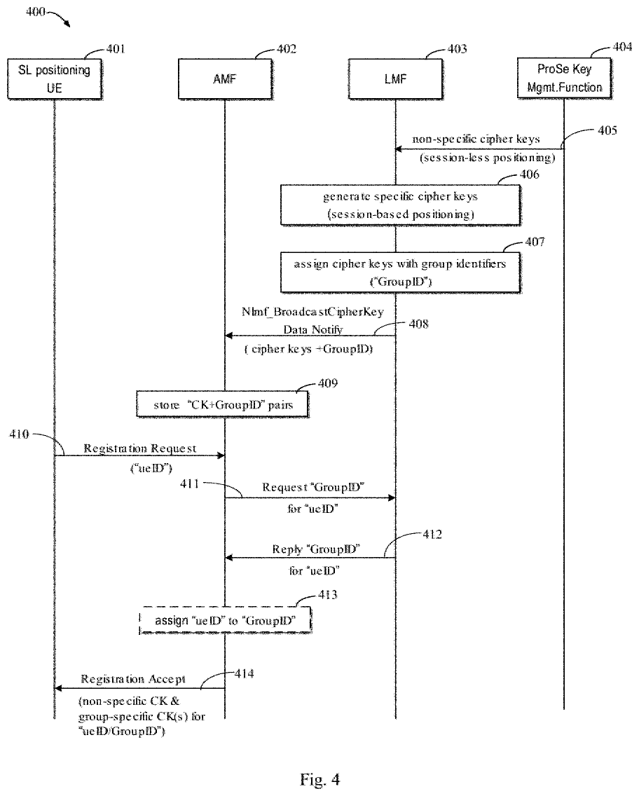

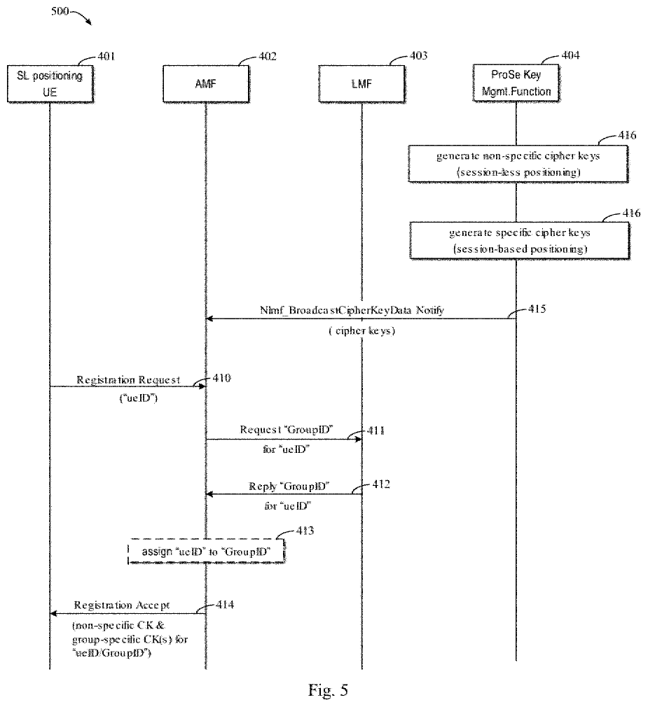

Now some other embodiments of the present disclosure herein will be described in detail with reference to FIGS. 4 and 5 below for the purpose of clearer understanding.

More specifically, some embodiments of the present disclosure propose that the LMF keeps control of how cipher keys are associated with the UEs but it is the AMF who distributes the keys to actual UEs while using the secure UE-AMF Non Access Stratum (NAS) context. Different cipher keys are provisioned for session-based positioning and session-less positioning. Session-based positioning is understood as a closed-group positioning by UEs who interact with each other (e.g., as part of multi-RTT method) within an established positioning session, characterized e.g. by minimum pre-defined positioning accuracy. A positioning session involves the exchange of acknowledged control messages between the involved entities (target UE and anchor UEs), and is typically the case of positioning applications that must satisfy certain quality of service (QOS) requirements. Session-specific keys are needed to protect sensitive session information such as absolute anchor location information (required for absolute positioning).

Session-less positioning is understood as positioning eliminating context/session establishment where any target UE can freely benefit from existing PRS transmissions in an opportunistic fashion (i.e., without acknowledging measurements and without providing any report to other entities). Main applications are relative ranging for overhead-free methods such as Observed Time Difference Of Arrival (OTDOA). Here, only Public Land Mobile Network (PLMN)-specific cipher keys are needed to ensure wide mutual compatibility of all UEs belonging to the same PLMN.

FIG. 4 illustrates an example of a process 400 for securing sidelink groupcast/broadcast communications in accordance with some example embodiments of the present disclosure. An LMF-centric example is shown in FIG. 4. It is understood that the process 400 can be considered as a more specific example of the process 200 in FIG. 2. In this regard, the SL positioning UE 401 in FIG. 4 can be considered as the terminal device 110 in FIG. 1. AMF 402 in FIG. 4 can be considered as the network device 131 in FIG. 1. LMF 403 in FIG. 4 can be considered as the network device 132 in FIG. 1. PKMF 404 in FIG. 4 can be considered as the network device 133 in FIG. 1.

In the process 400, at 405, The LMF 403 obtains non-specific cipher keys (CK) from the PKMF. These keys allow encrypting UE communications such that all UEs within the same PLMN can decipher them. Preferably, such keys are then used for session-less positioning where no or only minimal prior context is established between the target and anchor UEs.

At 406, the LMF 403 can also generate group-specific CKs for secure information exchange within a predefined group of UEs. These group-specific keys are then used for session-based positioning. UEs, that are not part of the session, would not be able to decrypt the information exchanged, e.g. absolute anchor coordinates. In this example, at 407, the LMF 403 assigns a group-specific CK to each session or a group of otherwise associated UEs. Each group is characterized by a “GroupID”. At 408, the mapping of “CK” and “GroupID” (“CK+GroupID”) is then communicated to the AMF by using the “NImf BroadcastCipherKeyData” notification message.

At 409, the AMF 402 then stores this “CK+GroupID” information. Upon a NAS Registration Request from a UE (identified by “ueID”), the AMF on-demand retrieves from the LMF the group association of that particular UE (410). This is done by “Request GroupID” and “Reply GroupID” messages at 411 and 412. The AMF 402 can internally maintain the mapping of different UEs to different groups to avoid repetitive requests to the LMF 403 (e.g., during NAS registration renewal). At 413, the AMF 402 assigns “ueID” to “GroupID”.

At 414, the AMF 402 then provides the UE with the appropriate CKs. By default, the non-specific CKs are assigned. If approved by the LMF 403, also group-specific keys are delivered to reflect/enable the membership of said UE in (LMF-controlled) positioning sessions.

FIG. 5 illustrates an example of a process 500 for securing sidelink groupcast/broadcast communications in accordance with some example embodiments of the present disclosure. An AMF-centric example is shown in FIG. 5. For the sake of brevity, only the difference between the process 500 and the process 400 is described here, and the same or similar details will not be repeated, and may make reference to each other.

As shown in FIG. 5, the major difference is that the AMF 402 stores and manages the CKs. For example, the AMF 402 can receive non-specific cipher keys and/or group specific cipher keys from the PKMF 404 (415). The PKMF 404 may generate at least one of non-specific and group specific cipher keys (416). It should be understood that at least one of non-specific and group specific cipher keys may be generated by other function block in the CN 130. And the AMF 402 can obtain non-specific cipher keys and/or group specific cipher keys from the other function block in the CN 130. The LMF 403 remains in the control of the actual assignment of CKs to individual UEs.

With any of the above processes, an improved solution for the security of SL groupcast/broadcast communication for sidelink positioning is provided, thereby address at least one of the deficiencies mentioned above.

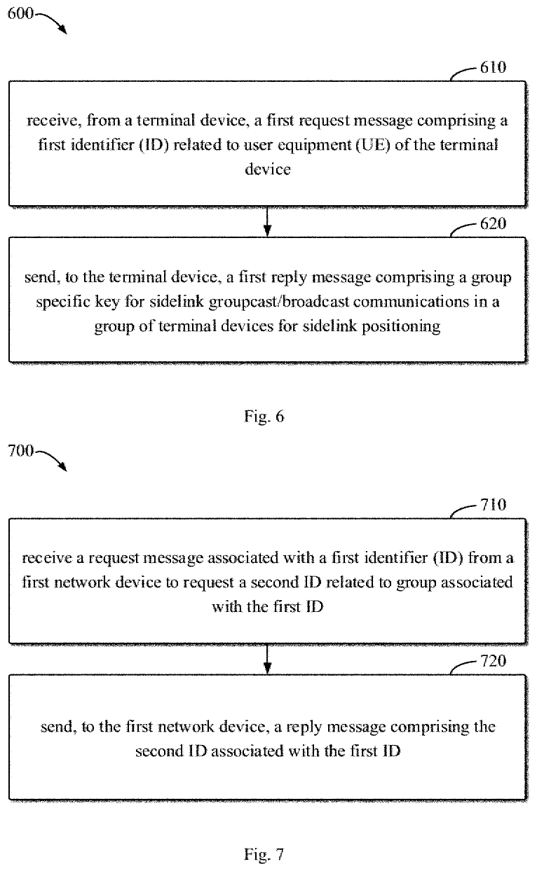

FIG. 6 shows a flowchart of an example method 600 implemented at a network device in accordance with some embodiments of the present disclosure. For the purpose of discussion, the method 600 will be described from the perspective of the network device 131 with reference to FIG. 1 or a first network device.

At block 610, the network device 131 receives, from a terminal device, a first request message comprising a first identifier (ID) related to user equipment (UE) of the terminal device. At block 620, the network device 131 sends, to the terminal device, a first reply message comprising a group specific key for sidelink groupcast/broadcast communications in a group of terminal devices for sidelink positioning.

In some embodiments, the network device 131 sends a second request message associated with the first ID to a second network device to request a second ID related to group associated with the first ID, wherein the second ID is indicative of the group of terminal devices. The network device 131 receives, from the second network device, a second reply message comprising the second ID associated with the first ID.

In some embodiments, prior to receiving the first request message from the terminal device, the network device 131 receives, from the second network device, mapping information between the second ID and the group specific key. The network device 131 stores the mapping information between the second ID and the group specific key In some embodiments, the network device 131 determines the group specific key based on the second ID in the received second reply message and the mapping information.

In some embodiments, based on the received second reply message from the second network device, the network device 131 stores mapping information between the first ID and the second ID.

In some embodiments, prior to receiving the first request message from the terminal device, the network device 131 receives the group specific key from the second network device or a third network device.

In some embodiments, the second reply message further comprises a non-specific key for sidelink communications of the first terminal device for sidelink positioning.

In some embodiments, the network device 131 receives the non-specific key from the second network device or the third network device.

In some embodiments, the group specific key is used for session-based sidelink positioning. In some embodiments, the non-specific key is used for session-less sidelink positioning.

FIG. 7 shows a flowchart of an example method 700 implemented at a network device in accordance with some embodiments of the present disclosure. For the purpose of discussion, the method 700 will be described from the perspective of the network device 132 with reference to FIG. 1 or a second network device.

At block 710, the network device 132 receives a request message associated with a first identifier (ID) from a first network device to request a second ID related to group associated with the first ID, wherein the first ID is related to user equipment (UE) of a terminal device, and the second ID is indicative of a group of terminal devices for sidelink positioning. At block 720, the network device 132 sends, to the first network device, a reply message comprising the second ID associated with the first ID.

In some embodiments, prior to receiving the request message from the first network device, the network device 132 assigns a group specific key with the second ID, wherein the group specific key is used for sidelink groupcast/broadcast communications in the group of terminal devices for sidelink positioning. The network device 132 sends, to the first network device, mapping information between the second ID and the group specific key.

In some embodiments, prior to assigning the group specific key with the second ID, the network device 132 generates the group specific key.

In some embodiments, prior to assigning the group specific key with the second ID, the network device 132 receives the group specific key from a third network device.

In some embodiments, the network device 132 receives, from a third network device, a non-specific key for sidelink communications of the terminal device for sidelink positioning.

In some embodiments, the group specific key is used for session-based sidelink positioning. In some embodiments, the non-specific key is used for session-less sidelink positioning.

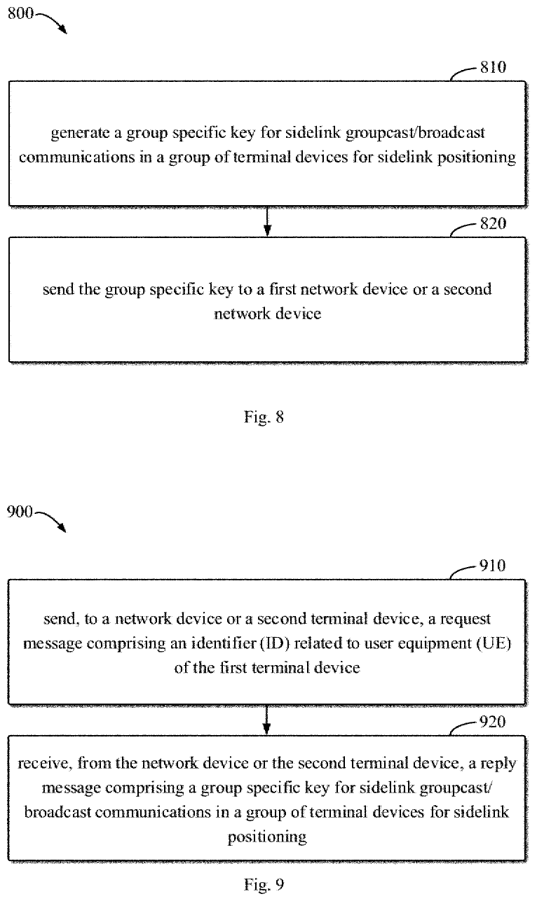

FIG. 8 shows a flowchart of an example method 800 implemented at a network device in accordance with some embodiments of the present disclosure. For the purpose of discussion, the method 800 will be described from the perspective of the network device 133 with reference to FIG. 1 or a third network device.

At block 810, the network device 133 generates a group specific key for sidelink groupcast/broadcast communications in a group of terminal devices for sidelink positioning. At block 820, the network device 133 sends the group specific key to a first network device or a second network device.

In some embodiments, the network device 133 generates a non-specific key for sidelink communications of a terminal device for sidelink positioning. The network device 133 sends the non-specific key to the first network device or the second network device.

In some embodiments, the group specific key is used for session-based sidelink positioning. In some embodiments, the non-specific key is used for session-less sidelink positioning.

FIG. 9 shows a flowchart of an example method 900 implemented at a terminal device in accordance with some embodiments of the present disclosure. For the purpose of discussion, the method 900 will be described from the perspective of the terminal device 110 with reference to FIG. 1 or a first terminal device.

At block 910, the terminal device 110 sends, to a network device or a second terminal device, a request message comprising an identifier (ID) related to user equipment (UE) of the first terminal device. At block 920, the terminal device 110 receives, from the network device or the second terminal device, a reply message comprising a group specific key for sidelink groupcast/broadcast communications in a group of terminal devices for sidelink positioning.

In some embodiments, the reply message further comprises a non-specific key for sidelink communications of the first terminal device for sidelink positioning.

In some embodiments, the group specific key is used for session-based sidelink positioning. In some embodiments, the non-specific key is used for session-less sidelink positioning.

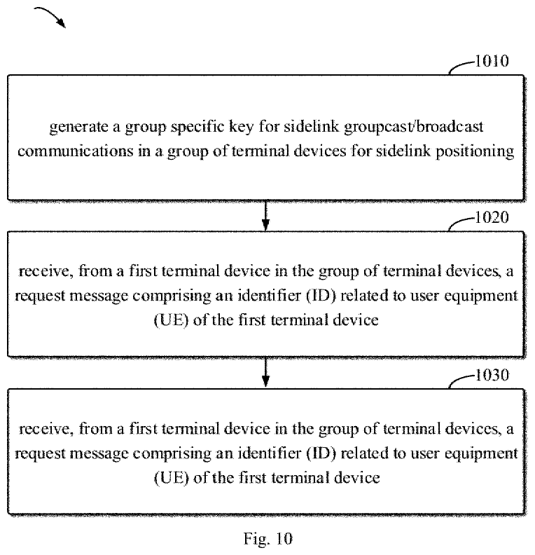

FIG. 10 shows a flowchart of an example method 1000 implemented at a terminal device in accordance with some embodiments of the present disclosure. For the purpose of discussion, the method 1000 will be described from the perspective of the terminal device 120 with reference to FIG. 1 or a second terminal device.

At block 1010, the terminal device 120 generates a group specific key for sidelink groupcast/broadcast communications in a group of terminal devices for sidelink positioning. At block 1020, the terminal device 120 receives, from a first terminal device in the group of terminal devices, a request message comprising an identifier (ID) related to user equipment (UE) of the first terminal device. At block 1030, the terminal device 120 sends, to the first terminal device, a reply message comprising the group specific key.

In some embodiments, the reply message further comprises a non-specific key for sidelink communications of the first terminal device for sidelink positioning.

In some embodiments, the group specific key is used for session-based sidelink positioning. In some embodiments, the non-specific key is used for session-less sidelink positioning.

In some embodiments, an apparatus capable of performing the method 600 (for example, the network device 131) may comprise means for performing the respective steps of the method 600. The means may be implemented in any suitable form. For example, the means may be implemented in a circuitry or software module.

In some embodiments, the apparatus comprises: means for receiving, from a terminal device, a first request message comprising a first identifier (ID) related to user equipment (UE) of the terminal device; and means for sending, to the terminal device, a first reply message comprising a group specific key for sidelink groupcast/broadcast communications in a group of terminal devices for sidelink positioning.

In some embodiments, the apparatus further comprises: means for sending a second request message associated with the first ID to a second network device to request a second ID related to group associated with the first ID, wherein the second ID is indicative of the group of terminal devices; and means for receiving, from the second network device, a second reply message comprising the second ID associated with the first ID.

In some embodiments, the apparatus further comprises: means for prior to receiving the first request message from the terminal device, receiving, from the second network device, mapping information between the second ID and the group specific key; and means for storing the mapping information between the second ID and the group specific key.

In some embodiments, the apparatus further comprises: means for determining the group specific key based on the second ID in the received second reply message and the mapping information.

In some embodiments, the apparatus further comprises: means for based on the received second reply message from the second network device, storing mapping information between the first ID and the second ID.

In some embodiments, the apparatus further comprises: means for prior to receiving the first request message from the terminal device, receiving the group specific key from the second network device or a third network device.

In some embodiments, the second reply message further comprises a non-specific key for sidelink communications of the first terminal device for sidelink positioning.

In some embodiments, the apparatus further comprises: means for receiving the non-specific key from the second network device or the third network device.

In some embodiments, the group specific key is used for session-based sidelink positioning. In some embodiments, the non-specific key is used for session-less sidelink positioning.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

In some embodiments, an apparatus capable of performing the method 700 (for example, the network device 132) may comprise means for performing the respective steps of the method 700. The means may be implemented in any suitable form. For example, the means may be implemented in a circuitry or software module.

In some embodiments, the apparatus comprises: means for receiving a request message associated with a first identifier (ID) from a first network device to request a second ID related to group associated with the first ID, wherein the first ID is related to user equipment (UE) of a terminal device, and the second ID is indicative of a group of terminal devices for sidelink positioning; and means for sending, to the first network device, a reply message comprising the second ID associated with the first ID.

In some embodiments, the apparatus further comprises: means for prior to receiving the request message from the first network device, assigning a group specific key with the second ID, wherein the group specific key is used for sidelink groupcast/broadcast communications in the group of terminal devices for sidelink positioning; and means for sending, to the first network device, mapping information between the second ID and the group specific key.

In some embodiments, the apparatus further comprises: means for prior to assigning the group specific key with the second ID, generating the group specific key.

In some embodiments, the apparatus further comprises: means for prior to assigning the group specific key with the second ID, receiving the group specific key from a third network device.

In some embodiments, the apparatus further comprises: means for receiving, from a third network device, a non-specific key for sidelink communications of the terminal device for sidelink positioning.

In some embodiments, the group specific key is used for session-based sidelink positioning. In some embodiments, the non-specific key is used for session-less sidelink positioning.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

In some embodiments, an apparatus capable of performing the method 800 (for example, the network device 133) may comprise means for performing the respective steps of the method 800. The means may be implemented in any suitable form. For example, the means may be implemented in a circuitry or software module.

In some embodiments, the apparatus comprises: means for generating a group specific key for sidelink groupcast/broadcast communications in a group of terminal devices for sidelink positioning; and means for sending the group specific key to a first network device or a second network device.

In some embodiments, the apparatus further comprises means for generating a non-specific key for sidelink communications of a terminal device for sidelink positioning; and means for sending the non-specific key to the first network device or the second network device.

In some embodiments, the group specific key is used for session-based sidelink positioning. In some embodiments, the non-specific key is used for session-less sidelink positioning.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

In some embodiments, an apparatus capable of performing the method 900 (for example, the terminal device 110) may comprise means for performing the respective steps of the method 900. The means may be implemented in any suitable form. For example, the means may be implemented in a circuitry or software module.

In some embodiments, the apparatus comprises: sending, to a network device or a second terminal device, a request message comprising an identifier (ID) related to user equipment (UE) of the first terminal device; and means for receiving, from the network device or the second terminal device, a reply message comprising a group specific key for sidelink groupcast/broadcast communications in a group of terminal devices for sidelink positioning.

In some embodiments, the reply message further comprises a non-specific key for sidelink communications of the first terminal device for sidelink positioning.

In some embodiments, the group specific key is used for session-based sidelink positioning. In some embodiments, the non-specific key is used for session-less sidelink positioning.

In some embodiments, the apparatus further comprises means for performing other steps in some embodiments of the method 900. In some embodiments, the means comprises at least one processor; and at least one memory including computer program code, the at least one memory and computer program code configured to, with the at least one processor, cause the performance of the apparatus.

In some embodiments, an apparatus capable of performing the method 1000 (for example, the terminal device 120) may comprise means for performing the respective steps of the method 1000. The means may be implemented in any suitable form. For example, the means may be implemented in a circuitry or software module.

In some embodiments, the apparatus comprises: generating a group specific key for sidelink groupcast/broadcast communications in a group of terminal devices for sidelink positioning; means for receiving, from a first terminal device in the group of terminal devices, a request message comprising an identifier (ID) related to user equipment (UE) of the first terminal device; and means for sending, to the first terminal device, a reply message comprising the group specific key.

In some embodiments, the reply message further comprises a non-specific key for sidelink communications of the first terminal device for sidelink positioning.

In some embodiments, the group specific key is used for session-based sidelink positioning. In some embodiments, the non-specific key is used for session-less sidelink positioning.

In some embodiments, the apparatus further comprises means for performing other steps in some embodiments of the method 1000. In some embodiments, the means comprises at least one processor; and at least one memory including computer program code, the at least one memory and computer program code configured to, with the at least one processor, cause the performance of the apparatus.

FIG. 11 is a simplified block diagram of a device 1100 that is suitable for implementing embodiments of the present disclosure. The device 1100 may be provided to implement the communication device, for example the terminal device 110, the terminal device 120, the network device 131, the network device 132 or the network device 133 as shown in FIG. 1. As shown, the device 1100 includes one or more processors 1110, one or more memories 1140 coupled to the processor 1110, and one or more transmitters and/or receivers (TX/RX) 1140 coupled to the processor 1110.

The TX/RX 1140 is for bidirectional communications. The TX/RX 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1220. The processor 1110 may perform any suitable actions and processing by loading the program 1130 into the RAM 1220.

The embodiments of the present disclosure may be implemented by means of the program 1130 so that the device 1100 may perform any process of the disclosure as discussed with reference to FIGS. 2 to 10. The embodiments of the present disclosure may also be implemented by hardware or by a combination of software and hardware.

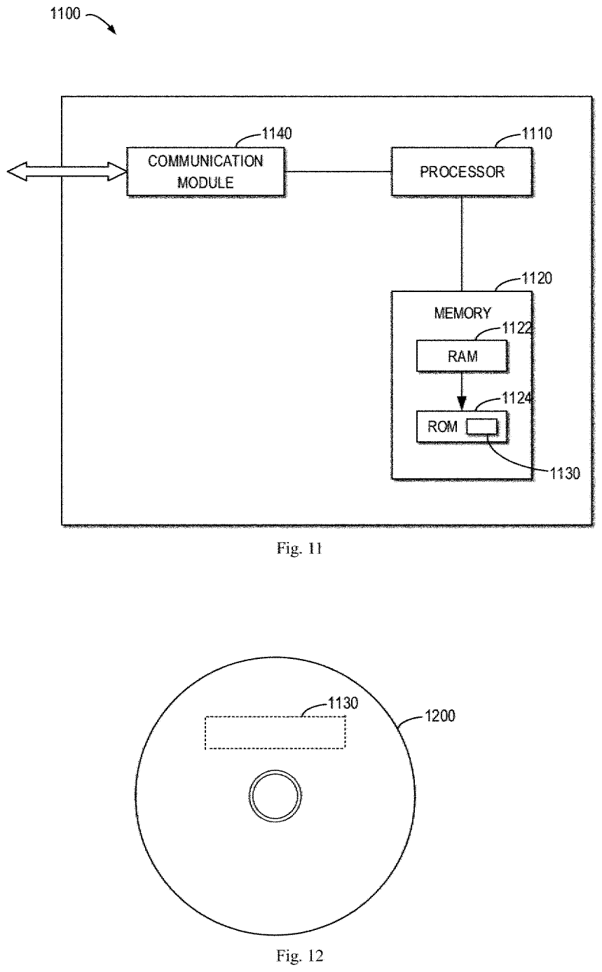

In some embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like. FIG. 12 shows an example of the computer readable medium 1200 in form of CD or DVD. The computer readable medium has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600, 700, 800, 900 or 1000 as described above with reference to FIGS. 6, 7, 8, 9 or 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first network device comprising:
at least one processor; and
at least one memory storing instructions of an access and mobility function (AMF), wherein the instructions, when executed by the at least one processor, cause the first network device at least to perform operations, the operations comprising:
receiving, from a terminal device, a first request message to register the terminal device with the AMF, the first request message comprising a first identifier (ID) related to the terminal device; and
sending, to the terminal device, a first reply message comprising a group specific key to be used for sidelink groupcast/broadcast communications between the terminal device and at least one other terminal device included in a group of terminal devices for sidelink positioning.

2. The first network device of claim 1, wherein the operations further comprise to:
sending a second request message associated with the first ID to a location management function (LMF) of the communication network to request a second ID related to group associated with the first ID, wherein the second ID identifies the group of terminal devices; and
receiving, from the LMF, a second reply message comprising the second ID associated with the first ID.

3. The first network device of claim 1, wherein the operations further comprise:
prior to receiving the first request message from the terminal device, receiving, from the LMF, mapping information indicative of a mapping between the second ID and the group specific key; and
storing the mapping information.

4. The first network device of claim 3, wherein the operations further comprise:
determining the group specific key based on the second ID in the second reply message and the mapping information.

5. The first network device of claim 2, wherein the operations further comprise:
based on the second reply message from the LMF, storing mapping information indicative of a mapping between the first ID and the second ID.

6. The first network device of claim 1, wherein the operations further comprise
prior to receiving the first request message from the terminal device, the group specific key from the LMF or a Proximity Services Key Management Function of the communication network.

7. The first network device of claim 1, wherein the second reply message further comprises a non-specific key for sidelink communications of the first terminal device for sidelink positioning.

8. The first network device of claim 7, wherein the operations further comprise:
the non-specific key from the LMF or the Proximity Services Key Management Function.

9. The first terminal device of claim 7, wherein at least one of the following:
the group specific key is used for session-based sidelink positioning; or
the non-specific key is used for session-less sidelink positioning.

10-18. (canceled)

19. A first terminal device comprising:
at least one processor; and
at least one memory storing instructions that, when executed by the at least one processor, cause the first terminal device at least to perform operations, the operations comprising:
sending, to an access and mobility function (AMF) of a communication network or a second terminal device, a request message comprising an identifier (ID) the first terminal device; and
receiving, from the AME or the second terminal device, a reply message comprising a group specific key to be used for sidelink groupcast/broadcast communications between terminal devices in a group of terminal devices for sidelink positioning, wherein the terminal devices in the group of terminal devices include the first terminal device and the second terminal device.

20. The first terminal device of claim 19, wherein the reply message further comprises a non-specific key for sidelink communications of the first terminal device for sidelink positioning.

21. The first terminal device of claim 20, wherein at least one of the following:
the group specific key is used for session-based sidelink positioning; or
the non-specific key is used for session-less sidelink positioning.

22. A second terminal device comprising:
at least one processor; and
at least one memory storing instructions that, when executed by the at least one processor, cause the second terminal device at least to perform operations, the operations comprising:
generating a group specific key for sidelink groupcast/broadcast communications between the terminal device and at least one other terminal device included in a group of terminal devices for sidelink positioning;
receiving, from a first terminal device in the group of terminal devices, a request message comprising an identifier (ID) of the first terminal device; and
sending, to the first terminal device, a reply message comprising the group specific key.

23. The second terminal device of claim 22, wherein the reply message further comprises a non-specific key for sidelink communications of the first terminal device for sidelink positioning.

24. The second terminal device of claim 23, wherein at least one of the following:
the group specific key is used for session-based sidelink positioning; or
the non-specific key is used for session-less sidelink positioning.

25-30. (canceled)
